(19) United States
(12) Patent Application Publication
(10) Pub. No.: US 2019/0256398 A1
(43) Pub. Date: Aug. 22, 2019

(54) SUCTION SUPPORT FOR GLASS

(71) Applicant: SAINT-GOBAIN GLASS FRANCE, COURBEVOIE (FR)

(72) Inventors: Arthur PALMANTIER, AACHEN (DE); Achim ZEICHNER, HERZOGENRATH (DE); Jack PENNERS, HERZOGENRATH (DE); Herbert RADERMACHER, RAEREN (BE); Peter SCHILLINGS, ESCHWEILER (DE)

(21) Appl. No.: 16/320,363

(22) PCT Filed: Apr. 5, 2017
(86) PCT No.: PCT/FR2017/050814

§ 371 Date: Jan. 24, 2019

(30) Foreign Application Priority Data
Jul. 25, 2016 (FR) 1657135
Jul. 25, 2016 (FR) 1657136

(51) Int. Cl. C03B 35/14; C03B 23/035; C03B 23/025; C03B 35/20; C03B 23/03; C03B 40/00

(52) U.S. Cl. CPC C03B 35/145; C03B 23/0357; C03B 23/0252; C03B 2225/02; C03B 23/03; C03B 40/005; C03B 35/207

(57) ABSTRACT

A frame for supporting a sheet of glass, referred to as a suction frame, includes a contact path for receiving the periphery of the underside face of the sheet of glass, and includes a suction system able to apply suction to the underside face of the sheet in order to enhance the retention of the sheet by the frame. This frame may form part of a device for the hot-bending of the sheet and convey the sheet with high acceleration or deceleration through a heating enclosure for the purposes of the hot-bending of the sheet.

The invention relates to a frame for supporting the periphery of a sheet of glass, said frame being provided with a suction system holding the sheet firmly against the frame for holding it better in place on the frame despite the movement of the latter.

The term “frame” denotes a support of the ring type surrounding an opening (also referred to as “aperture”). Numerous bending methods are known. According to EP448447 or EP0705798, sheets of glass are gravity bent on double frames, the glass passing from a pre-bending frame to a finishing frame by the retraction of one frame with respect to the other. The use of this type of device allows progressive bending to be applied and avoids the phenomenon of reverse-bending in the corners of the sheet. According to certain methods as described in WO2004/087590 or WO2006072721, the glass is first of all gravity bent on a bending frame, then press-bent against an upper bending form or a lower bending form. These methods entail the creation of a multiplicity of gravity bending supports passing one after another as a sequence of supports. According to EP255422 a sheet of glass is bent by upward blowing against an upper bending form. U.S. Pat. No. 5,906,668 may also be cited.

In the conventional gravity bending methods, the bending supports pass one after another through a tunnel furnace raised to the plastic deformation temperature of the glass. In these methods, the supports are not subjected to great accelerations and that means that the sheet remains correctly in position on the support without there being a need to hold it on the support. The present invention offers a solution for holding a sheet of glass correctly in position on a frame that is to support a sheet of glass if the frame is subjected to high accelerations or decelerations, in particular of at least 1500 mm/sec², or even of at least 3000 mm/sec², or even of at least 1500 mm/sec². In general, the acceleration or deceleration remains below 7500 mm/sec². The suction applied to the sheet by the suction system of the suction frame is in operation during said acceleration or deceleration.

The invention relates first of all to a frame for supporting a sheet of glass, referred to as a suction frame, comprising a contact path for receiving the periphery of the underside face of the sheet of glass, and comprising a suction system able to act upon the underside face of the sheet in order to enhance the retention of the sheet by said support. The suction is preferably strong enough that this retention causes the glass to be immobilized with respect to the suction frame, which means to say that the glass cannot move laterally with respect to the suction frame despite the high acceleration or deceleration experienced by the suction frame supporting the glass. The term “lateral” or “laterally” connected with a movement means that this movement is horizontal or comprises at least one horizontal component.

The suction frame generally has a width comprised in the range from 3 to 150 mm and more generally from 3 to 90 mm. These values are given after said suction frame has been fitted with a fibrous material (well known to those skilled in the art) that comes into contact with the glass in order to soften the contact between the suction frame and the glass and thermally insulate the glass from the mold. These width values therefore include any potential widening of the contact path caused by the fibrous material. A wide contact path, for example measuring 25 mm or more, in particular a width comprised in the range from 25 to 90 mm and for preference in the range from 50 to 90 mm is preferred because that allows the weight of the sheet of glass to be spread over a larger surface area and therefore makes it possible to reduce the risks of marking the glass, in particular at high temperatures (in particular from 400 to 750° C.). In addition, because of the greater friction, a larger contact area provides greater retention of the glass on the suction frame and the position of the glass on this support is better preserved despite the lateral movements at high accelerations or decelerations. During the lateral movement of the bending support the upper face of the glass is generally not in contact with any tool, which means to say is wholly in contact with the gaseous atmosphere.

The suction may be applied to the underside face of the sheet either through the contact path of the frame at the periphery of the sheet or in a zone internal to the frame so as to apply suction on the central zone of the sheet. The notion of the periphery of the sheet may be dependent on its size since, for a large sheet, it may be considered that the support may extend further from the edge toward the center of the sheet. The suction frame according to the invention does not generally come into contact with the glass inside this peripheral zone, which means to say no further than 150 mm away from the edge of the glass and generally no further than 40 mm away from the edge of the glass. The frame comprises a contact path for contact with the glass, this contact path being rigid enough that it does not deform under the weight of the glass or throughout the time that it is supporting the glass. The frame is formed of a metal frame the upper surface of which is machined to the shape desired for the glass, this path being covered with a fibrous material that softens the contact with the glass. The metal frame is rigid and does not deform while it is being used in the context of the present invention. The fibrous material is flexible and porous and conforms to the shape of the machined upper surface. In addition to softening the contact with the glass, it also acts as a thermal insulator. The contact path is therefore in reality made up of the upper face of this fibrous material which is flexible, but which does not deform in use because of the rigid frame supporting it and giving it its shape. This material made of refractory fiber as is commonly used by those skilled in the art to soften contact between a metallic tool and glass is generally of the woven or nonwoven or knitted type and generally has a thickness ranging from 0.5 to 12 mm. Over this total thickness, the material may be made up of several layers of one same material or of different materials.

Thus, according to an alternative form, the suction is applied through orifices (which means to say openings) in the contact path of the suction frame. In this case, the frame comprises at least one closed chamber under the contact path, orifices passing through the frame from the closed chamber to the contact path, namely through the machined surface of the frame and of the fibrous material in direct contact with the glass. The inside of the closed chamber is connected by a duct to a vacuum-producing system. A sub-atmospheric pressure may thus be created in the closed chamber to create suction through the orifices opening into the upper machined surface of the frame, this suction extending through the interposed fibrous material providing contact with the glass. The fibrous material allows gases through (the fibrous material is not gastight), and the space between the fibers is considered to be orifices (which means to say openings) through which the suction can pass. The glass is held firmly on the contact path by the suction. In general, the suction is not one of the tools used for accentuating the bending of the glass, although the glass nevertheless bends under gravity when it is at its plastic deformation temperature. The suction here has more of a limiting action on the bending and provides the possibility of influencing this bending. Specifically, during gravity bending on a frame, the glass slips on the frame during the bending and as a result of the bending. During this slippage, the edge of the glass moves slightly toward the center of the frame. The suction applied to the glass by the suction frame of the invention has a tendency to restrain the glass and therefore to limit this slipping of the glass. The suction can therefore be varied in order to control the gravity bending. A strong suction reduces the amount of gravity bending.

The suction frame is first of all a frame that allows the glass to be transported with high acceleration or deceleration. The contact path has a shape corresponding to the shape desired at the end of supporting on the suction frame. Finally, a wider contact path may more easily be equipped with a suction system acting on the underside face of the sheet. According to this alternative form, the contact path of the suction frame is equipped with orifices through which the suction is applied. In the case of a narrow contact area (for example of 3 mm), the weight of the glass is concentrated over a smaller area, and the risks of marking are higher. In addition, a path as narrow as this may prove more difficult to equip with an effective suction system. This is why, according to this alternative form, the suction frame advantageously combines a wide contact path, in particular having a width of at least 25 mm, in particular comprised in the range from 25 to 90 mm and for preference in the range from 50 to 90 mm, and a suction system acting on the underside face of the sheet through orifices in the contact path. The frame width and the suction are sufficient to secure the glass to the suction frame during an acceleration or deceleration of at least 1500 mm/sec², or even of at least 3000 mm/sec², or even of at least 5000 mm/sec².

During suction, the glass is held on the frame without moving laterally with respect to the latter despite the high acceleration or deceleration of the frame supporting the glass. At these moments the glass is therefore fixed laterally with respect to the frame and is secured to the suction frame in spite of the high acceleration or deceleration. The suction through the contact path may be achieved through just part of this path, in particular at two or three or four or five or six separate zones. All that is then required is for the machined surface of the suction frame to be pierced only at the locations corresponding to these zones, thereby very appreciably reducing the costs of manufacture as compared with a situation whereby all of the machined surface of the suction frame is equipped with orifices. Formed beneath each pierced zone is a closed chamber that can be placed under vacuum by a duct connected to a suction system. The suction is therefore generated only in the local zones. The effect of retention on the suction frame is sufficient and the system enabling it is less complex than if the suction were to affect the entire contact path of the suction frame. In order for a vacuum to be able to be created it is necessary for contact between the contact path of the suction frame and the glass to be sufficient, at least in certain zones equipped with suction orifices. Specifically, if the shapes of the contact path of the suction frame and of the glass differ too greatly, then all the suction will do is create an uninterrupted flow of air between the suction frame and the glass.

According to another alternative form, the suction is applied to the central zone of the sheet through the inside of the suction frame. In this case, the suction frame is provided with a plenum positioned under the central zone of the underside face of the sheet to impart a sub-atmospheric pressure thereto. This plenum is connected sealingly to the frame so as to be able to sustain a vacuum under the glass. The plenum is connected by a duct to a vacuum-producing system. In this configuration and depending on the intensity of the vacuum produced, the suction may cause the glass to bend. In general, the contact path is not planar but has a shape corresponding to that desired after bending on the suction frame. According to this alternative form, in order for the suction to play its part there needs to be sufficient sealing created between the contact path and the glass around the entire periphery of the glass as soon as the glass is placed on the contact path.

According to these two alternative forms, bearing in mind the fact that a fibrous material preferably covers the suction frame in order to soften the contact with the glass, the sealing between the glass and the contact path can not be perfect, but it simply needs to be sufficient for a pressure force to press on the glass in order to press the sheet firmly against the contact path. The open porosity of the fibrous material plays a part in the vacuum that can be created by suction and therefore also in the pressure force applied to the glass from above.

In addition to the effect of retention on the suction frame, a hot-bending is generally expected during the suction. The shape of the contact path therefore preferably does not have exactly the shape of the periphery of the sheet at the start of contact but rather that expected at the end of bending on said suction frame. The shape of the sheet at the start of contact must therefore not be very different than that expected at the end of bending because then there could be difficulties creating a seal between the contact path and the sheet. This is why any bending that might occur on the suction frame is relatively modest and may for example be of the pre-bending type, this pre-bending being followed by more pronounced bending using another bending means, in particular press bending. Any sheet of glass naturally has a certain flexibility which means that the simple fact of laying it on the suction frame will make it have a tendency to a certain extent and under the effect of its own weight to conform to the shape of the contour of the suction frame, even before any bending. In order for the suction to have an effect all that is required is for the contour to conform to the suction frame over a certain area of contact. Partial contact at the starting of the laying of the sheet on the suction frame may therefore suffice. This is especially true in the case of suction through orifices in the contact path of the suction frame. In this case, the suction may even potentially be restricted to these zones of contact with the suction frame right from the time of the laying of the glass thereon. However, it should be noted that in the case of those zones of the suction frame that do not make contact with the glass from the time of the laying of the glass thereon, the offset between the glass and the frame may potentially quickly close under the combined effect of the suction and of the gravity bending.

The suction that causes the retention of the glass on the suction frame is triggered before a forthcoming acceleration likely to destabilize the glass in the absence of this suction. Once the critical acceleration or critical braking (which means to say deceleration) is over or if the suction frame needs to have the glass unloaded from it, then the suction may be stopped. The suction system produces for example a sub-atmospheric pressure of 700 mbar (which means to say a vacuum of 300 mbar). The intensity of the vacuum in mbar is dependent on the way in which the suction is applied to the glass. For suction through the contact path, the suction is greater than the suction used when suction is applied to the central surface of the glass through the inside of the frame.

As soon as the suction stops, the pressure rises again to atmospheric pressure fairly quickly because ambient air can pass at least through the open porosity of the refractory material arranged between the rigid path of the suction frame and the glass. Moreover, at the same time as the suction stops, the duct creating the vacuum is returned to atmospheric pressure.

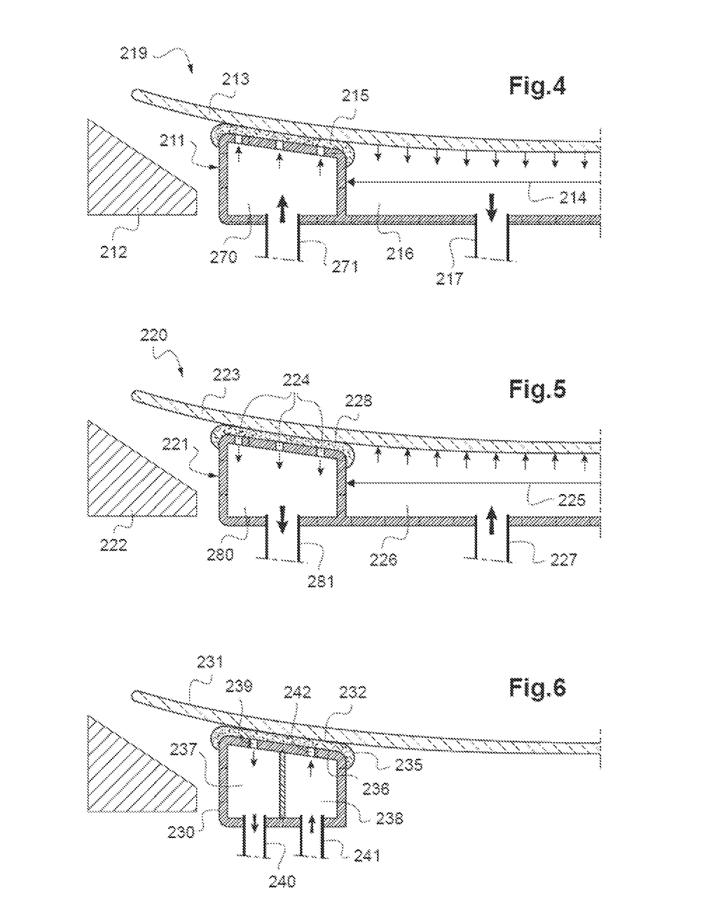

The suction frame according to the invention may also comprise a blowing system blowing toward the underside face of the glass. This blowing may have the objective of helping to regulate the retaining force pressing against the top face of the glass while reducing it, or of reducing the risk of marking of the glass through contact with the suction frame. Three alternative forms of such suction-blowing systems are listed hereinafter:
A. With the suction created on the central zone of the sheet through the inside of the suction frame (rather than through the contact path), blowing is generated through the contact path and the fibrous refractory material covering same. The objective is to reduce the risk of marking of the glass with the suction frame. The blowing creates an air cushion in the zone of glass/frame contact, thereby reducing the risk of marking of the glass. At the same time, suction is applied to the central zone of the glass to hold the glass on the frame. In order to create this blowing through the contact path, use is made of the means already described for creating suction through the contact path, except that the vacuum-generating system is replaced by a pressure-generating system. This system is more particularly described in FIG. 4.
B. With the suction being created through the contact path of the suction frame, blowing is applied at the same time to the central zone of the sheet through the inside of the suction frame; a plenum positioned under the central zone of the underside face of the sheet allows a pressure to be imparted to the latter that is higher than atmospheric pressure. This plenum is connected gastightly to the suction frame so as to be able to maintain the pressure under the glass. It is connected by a duct to a pressure-producing system. The objective of the blowing is to reduce the risk of marking of the glass with the suction frame. Suction is applied through the frame to hold the glass in position at the zone of glass/frame contact and at the same time, the central zone of the glass is blown on in order to create an air cushion and reduce the relative weight of the glass on the contact path. This system is more particularly described in FIG. 5.
C. With the suction created through a zone of the contact path of the suction frame, blowing is applied in parallel to another zone of the contact path of the suction frame. Several closed chambers may thus be formed under the machined surface of the suction frame, said machined surface being covered with a fibrous refractory material so as to accept the glass, at least one of these chambers, referred to as a suction chamber, being connected to a vacuum-creating system by a duct and being used to apply suction to the underside face of the glass, at least one other of these chambers, referred to as a blowing chamber, being placed under pressure by a duct and serving to blow onto the underside face of the glass. A suction chamber and a blowing chamber may be juxtaposed so that one follows after the other when progressing from the edge of the glazing toward the center. In particular, the suction chamber may be positioned closer to the edge of the glazing than the blowing chamber. The suction is used to hold the glass more firmly on the suction frame. The suction passes through orifices present in the machined upper surface of the suction frame, then through the fibrous material (of which the porosity that lets the gases through can be likened to orifices). The blowing of air is also applied through orifices pierced in the machined surface and through the interposed fibrous material providing contact with the glass. The objective is to reduce the risk of marking of the glass due to contact of the glass with the suction frame. Suction is applied through the frame to hold the glass in position at the corresponding zone of glass/frame contact and blowing is applied in order to create an air cushion between the glass and the suction frame and reduce the risk of marking of the glass. This system is more particularly described in FIG. 6.

Thus, according to the invention, the suction frame may also comprise a blowing system able to apply blowing through at least one local zone referred to as blowing zone of the contact path of the suction frame. The suction frame may comprise at least one closed chamber under the blowing zone of the contact path, referred to as a closed blowing chamber, orifices passing through the frame between the closed blowing chamber and the contact path, the closed blowing chamber being connected to the blowing system.

The invention also relates to a device for transporting a sheet of glass comprising the suction frame according to the invention and a conveying means for conveying said suction frame. The conveying means may confer upon the suction frame an acceleration or deceleration of at least 1500 mm/sec², or even of at least 3000 mm/sec², or even of at least 5000 mm/sec², and generally less than 7500 mm/sec². This acceleration or deceleration is generally applied laterally, which means to say horizontally or with at least one horizontal component. Such accelerations or decelerations are liable to destabilize the glass on its support in the absence of the retaining suction according to the invention. The conveying means may for example be used to move the glass from one position to another in a glass treatment process, in particular a hot-bending device. In particular, these various positions may correspond to those that allow tools to interact with the glass. These tools are generally above the glass. The suction frame according to the invention is of usefulness in particular in quickly and with high acceleration or deceleration transporting a sheet of glass between two positions, in particular in an enclosure heated to the hot-bending temperature of the glass. The suction frame thus shuttles back and forth between these two positions, pausing at each of them. For example, a first position may be a position at which the suction frame receives a sheet of glass released by an upper form and the second position may be a position in which the glass is bent against an upper form. The suction frame constantly makes the outbound journey (carrying the glass) and the return journey (without the glass) between these two positions at which it pauses.

The invention also relates to a device for the hot-bending of a sheet of glass comprising the transport device according to the invention, and a heating enclosure, the transport device allowing the frame to be conveyed into the enclosure.

Hot-bending is bending at a plastic deformation temperature of the glass, generally comprised in the range from 550 to 750° C. In particular, the bending device may comprise a bending support comprising the suction frame and an additional bending mold, of these two elements that are the suction frame and the bending mold, one being surrounded by the other when viewed from above, at least one of these two elements being able to be given a relative vertical movement with respect to the other. Thus, these various supports may pick up the glass alternately one after the other, the support that rises higher than the other taking charge of the glass via its periphery. A gravity pre-bending may potentially be performed on the suction frame, then an additional gravity bending may be performed on the additional bending mold.

The suction frame according to the invention may if appropriate act as a press-bending frame pressing against an upper mold. In this alternative form, the suction frame moves with a high acceleration or deceleration holding the glass in position by the suction according to the invention, gravity pre-bending of the glass taking place thereon before, during or after the movement, then the suction frame carrying the glass positions itself under an upper bending form, then the suction frame and the upper bending form have a relative vertical movement that brings them closer together so as to press the glass between them and perform press bending. The suction frame and the upper form then separate from one another and then the glass is removed from the press-bending zone to be cooled.

A bending method using the bending method according to the invention comprises conveying the suction frame supporting a sheet of glass into an enclosure raised to the plastic deformation temperature of the glass and bending the sheet. In particular, the bending may be performed at least partially on the suction frame, in particular by gravity bending. The bending may be performed on a bending support comprising the suction frame and a bending mold, of these two elements that are the suction frame and the bending mold, one being surrounded by the other when viewed from above, at least one of these two elements being given a relative vertical movement with respect to the other so as to transfer the sheet of glass from the suction frame to the bending mold, the suction applied to the sheet via the suction system of the suction frame not being in operation during this transfer.

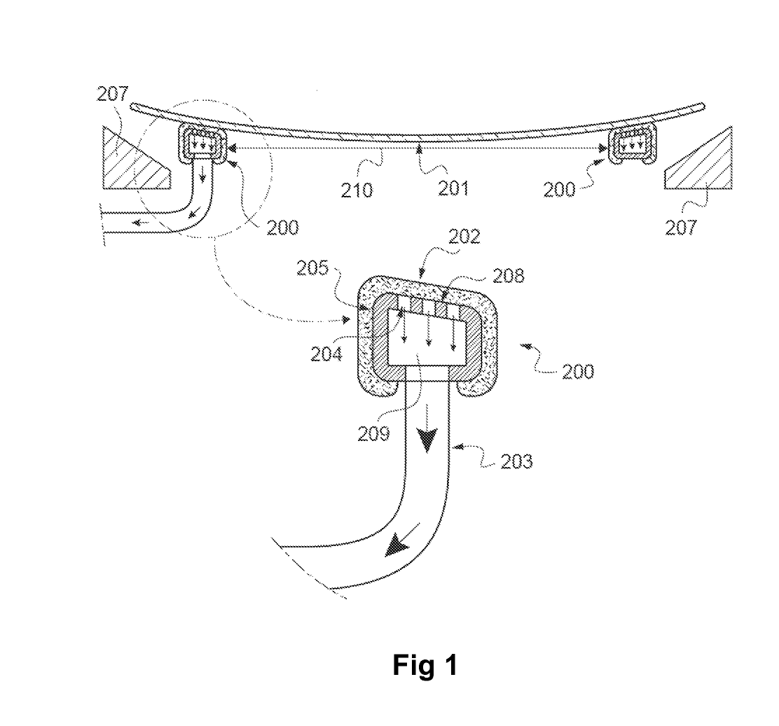

FIG. 1 depicts a suction frame 200 supporting a sheet of glass 201 via a contact path 202. When viewed from above, the suction frame and its contact path have the shape of a ring surrounding an opening 210. This contact path is made up of a refractory fibrous material 205 well known to those skilled in the art for equipping tools that are to come into contact with hot glass. This fibrous material in particular covers the machined upper surface 208 of the suction frame under which there has been constructed a closed chamber 209 capable of being placed under vacuum, said upper surface 208 being pierced. The fibrous material is flexible enough to conform to the shape of the machined upper surface 208 of the suction frame. The inside of the closed chamber 209 is connected to a vacuum-creating system by the duct 203. The suction passes through orifices 204 present in the machined upper surface of the suction frame and then through the fibrous material 205, the latter being designed not to be gastight. It is considered that it too comprises orifices through which the stream of suction air can pass. In this embodiment, the contact path is slightly curved. A small amount of pre-bending may be applied on this suction frame. Another bending tool consists of an additional frame 207 acting as a bending mold, which surrounds the suction frame 200. At the appropriate moment, the suction frame is lowered allowing the additional frame 207 to pick up the glass in order if appropriate to continue the gravity bending. The suction is initiated in order to hold the sheet on the suction frame during the transfer of the glass at high acceleration or deceleration. This transfer time can be put to use for applying gravity pre-bending on the suction frame. Once the glass is in the correct position, the suction is stopped so that the suction frame no longer retains the glass and so that the additional frame can pick up the sheet.

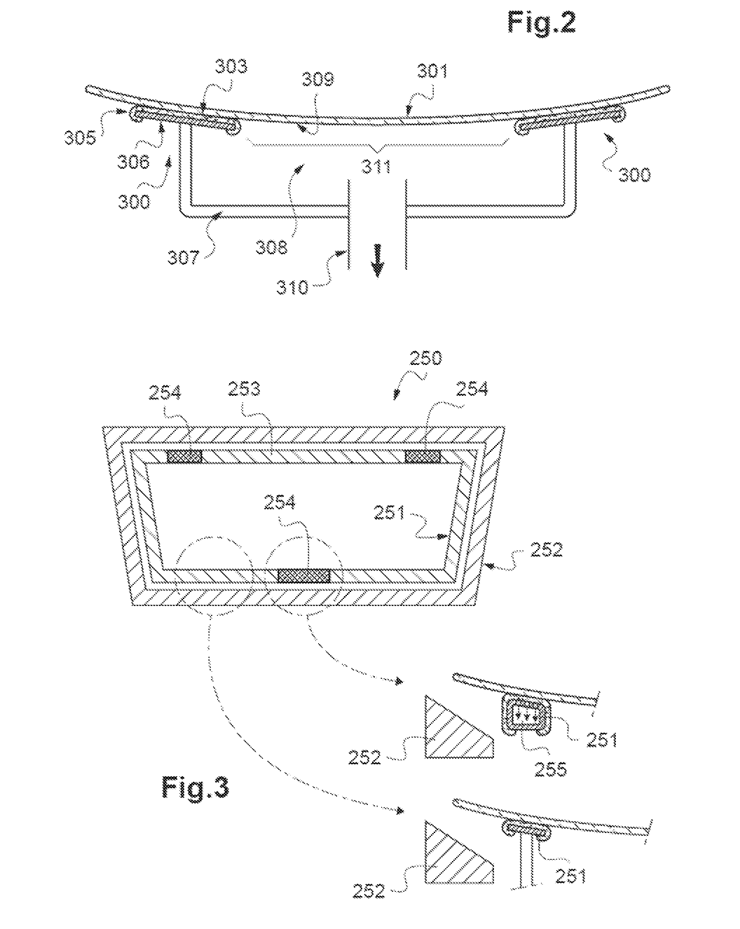

FIG. 2 depicts a suction frame 300 supporting a sheet of glass 301 via a contact path 303. This contact path is made up of a fibrous refractory material 305 well known to those skilled in the art for equipping tools that are to come into contact with hot glass. This fibrous material in particular covers the upper surface of a ring-shaped metal frame 306 surrounding an opening 311. The metal frame 306 gives the desired shape to the contact path, the fibrous material being flexible enough to conform to the shape of the upper face of the metal frame 306. The frame is connected by its opposite side from the contact path to a plenum 307 forming a volume 308 below the underside surface 309 of the sheet of glass. The plenum is connected to a duct 310 making it possible to generate a vacuum in the volume 308, after a sheet of glass has been set down on the contact path. Thus, the suction is applied to the central zone of the underside face 309 of the sheet, through the opening 311 surrounded by the suction frame. This vacuum accentuates the force applied to the upper face of the sheet 301. The sheet thus rests more firmly on the suction frame and is thus better held in position in spite of the lateral movements of the suction frame.

FIG. 3 depicts a view from above of a device 250 for bending a sheet of glass comprising a suction frame 251 and an additional frame 252 (acting as a bending mold) surrounding it. The contact path 253 of the suction frame comprises three zones 254 (crosshatched) pierced with orifices so that suction can be applied. The suction is therefore applied through just part of the contact path of the suction frame. Formed under the pierced zone is a closed chamber 255 that can be placed under vacuum by ducts (not depicted) connected to a suction system. The suction is therefore generated in just three local zones connected to a suction system. This localized suction reduces the costs of tooling and simplifies the suction system in the suction frame. The retention effect on the suction frame is sufficient and the system allowing this is less complex.

FIG. 4 depicts a cross section in side view of a device 219 for bending a sheet of glass 213 comprising a suction frame 211 and an additional frame 212 (acting as a bending mold) surrounding it. The suction is produced in a central zone of the glazing through the inside 214 of the suction frame. A plenum 216 positioned below the central zone of the underside face of the sheet 213 allows a sub-atmospheric pressure to be imparted thereto. This plenum is connected gastightly to the frame 211 so as to be able to sustain the vacuum under the glass. It is connected by a duct 217 to a vacuum-producing system. Blowing is generated at the same time through the contact path of the frame which path is provided with orifices. Specifically, a closed chamber 270 is formed under the contact path and a duct 271 allows it to be connected to a pressurized system allowing air to be blown through orifices of the machined upper surface of the metal frame of the suction frame and through the fibrous material 215 covering same. The material 215 made of refractory fibers softens the contact with the glass. At this stage, the glass 213 is picked up by the suction frame in a raised position, the additional frame 212 having to pick up the sheet later. The objective is to reduce the risk of marking of the glass with the suction frame. Air is blown through the frame to create an air cushion at the zone of glass/frame contact and reduce the risk of marking of the glass. At the same time, suction is applied to the central zone of the glass in order to hold it on the frame.

FIG. 5 depicts a cross section in side view of a device 220 for bending a sheet of glass 223 comprising a suction frame 221 and an additional frame 222 (acting as a bending mold) surrounding it. The suction is produced through the contact path equipped with orifices 224. This contact path comprises a refractory material 228 made of fibers that softens the contact with the glass. Blowing is generated at the same time in the central zone of the glazing through the inside 225 of the suction frame. A plenum 226 positioned under the central zone of the underside face of the sheet 223 allows a pressure to be imparted to the latter. This plenum is connected gastightly to the frame 221 so as to be able to maintain the pressure under the glass. It is connected by a duct 227 to a pressure-producing system. The objective of the blowing is to reduce the risk of marking of the glass with the suction frame. A closed chamber 280 is formed under the contact path and a duct 281 allows this to be connected to a vacuum system allowing air to be sucked through orifices in the machined upper surface of the metal frame of the suction frame and through the fibrous material 228 covering it. Suction is applied through the frame to hold the glass in position at the zone of glass/frame contact and at the same time air is blown onto the central zone of the glass to create an air cushion and reduce the relative weight of the glass on the contact path.

FIG. 6 depicts a suction frame 230 supporting a sheet of glass 231 via a contact path 232. This contact path is made up of a fibrous refractory material 235 covering the machined upper surface 236 of the suction frame under which two closed chambers 237 and 238 have been constructed. The chamber 237 can be placed under vacuum so as to apply suction to the glass through the machined surface pierced with orifices 239 and through the interposed fibrous material 235. The purpose of this suction is to reinforce the retention of the glass on the suction frame. The inside of the closed chamber 237 is connected to a vacuum-creating system via the duct 240. The suction is applied through orifices 239 present in the machined upper surface 236 of the suction frame and through the fibrous material 235. The chamber 238 contiguous with the chamber 237 may be pressurized by a duct 241. A blowing of air is then applied through orifices 242 pierced in the machined surface 236 and through the interposed fibrous material 235. The objective is to reduce the risk of marking of the glass as a result of contact between the glass and the suction frame. Suction is applied through the frame in order to hold the glass in position at the zone of glass/frame contact corresponding to the chamber 237. On this same suction frame 230 air is blown through the contact path 236 above the chamber 238 to create an air cushion and reduce the risk of marking of the glass.

1. A suction frame for supporting a sheet of glass, comprising a contact path for receiving a periphery of an underside face of the sheet of glass, and comprising a suction system adapted to apply suction to the underside face of the sheet of glass in order to enhance a retention of the sheet of glass by said suction frame.

2. The suction frame as claimed in claim 1, wherein the suction is applied through the contact path of the suction frame.

3. The suction frame as claimed in claim 2, wherein the suction is applied through local suction zones of the contact path of the suction frame.

4. The suction frame as claimed in claim 1, further comprising at least one closed suction chamber under the contact path, orifices passing through the suction frame between the closed suction chamber and the contact path, the closed suction chamber being connected to the suction system.

5. The suction frame as claimed in claim 1, comprising a blowing system adapted to blow through at least a local blowing zone of the contact path of the suction frame.

6. The suction frame as claimed in claim 5, further comprising at least one closed blowing chamber under the blowing zone of the contact path orifices passing through the frame between the closed blowing chamber and the contact path, the closed blowing chamber being connected to the blowing system.

7. The frame as claimed in claim 1, further comprising a plenum positioned below the central zone of the underside face of the sheet in order to impart thereto a pressure higher than atmospheric pressure.

8. The suction frame as claimed in claim 1, wherein the suction is applied to the central zone of the sheet of glass through the inside of the suction frame.

9. The suction frame as claimed in claim 8, further comprising a plenum positioned under the central zone of the underside face of the sheet of glass so as to be able to impart thereto a sub-atmospheric pressure.

10. The suction frame as claimed in claim 1, further comprising a blowing device allowing air to be blown through the contact path.

11. The suction frame as claimed in claim 1, wherein the suction is strong enough to secure the sheet of glass to the suction frame during an acceleration or deceleration of at least 1500 mm/sec².

12. The suction frame as claimed in claim 1, wherein the contact path for the sheet of glass has a width of at least 25 mm.

13. A device for transporting a sheet of glass comprising the suction frame of claim 1 and a conveyor for conveying said suction frame.

14. The device as claimed in claim 13, wherein the conveyor is adapted to confer upon the suction frame an acceleration or deceleration of at least 1500 mm/sec².

15. The device as claimed in claim 14, wherein the suction is able to hold the glass in position during an acceleration or deceleration.

16. A device for the hot-bending of a sheet of glass comprising a transport device of claim 13, and a heating enclosure, the transport device allowing the suction frame to be conveyed into the enclosure.

17. The device as claimed in claim 16, further comprising a bending support comprising the suction frame and a bending mold, one of the suction frame and the bending mold being surrounded by the other one of the suction frame and the bending mold when viewed from above, at least one of the suction frame and the bending mold being able to be given a relative vertical movement with respect to the other.

18. A method for transporting a sheet of glass comprising conveying the sheet of glass using the device of claim 13, said conveying comprising an acceleration or deceleration, the suction applied to the sheet of glass by the suction system of the suction frame being in operation during said acceleration or deceleration.

19. The method as claimed in claim 18, wherein the acceleration or deceleration is of at least 1500 mm/sec² and less than 7500 mm/sec².

20. A method for the hot-bending of a sheet of glass comprising transporting the sheet of glass using the method of claim 18, the suction frame supporting the sheet of glass being conveyed into an enclosure raised to the plastic deformation temperature of the glass, followed by the bending of the sheet.

21. The method as claimed in claim 20, wherein the bending is performed at least partially on the suction frame.

22. The method as claimed in claim 20, wherein the bending is performed on a bending support comprising the suction frame and a bending mold, one of the suction frame and bending mold being surrounded by the other one of the suction frame and bending mold when viewed from above, at least one of the suction frame and bending mold being given a relative vertical movement with respect to the other, so as to cause the sheet of glass to transfer from the suction frame to the bending mold, the suction applied to the sheet of glass by the suction system of the suction frame not being in operation during this transfer.

23. The method as claimed in claim 20, wherein the conveyor causes the suction frame to move alternately from one position to another in the enclosure, pausing in each position.

24. The method as claimed in claim 21, wherein the bending is performed by gravity bending.
